(19) United States
(12) Patent Application Publication
(10) Pub. No.: US 2006/0078219 A1
(43) Pub. Date: Apr. 13, 2006

(54) Image viewing and method for generating filters for filtering image feaures according to their orientation

(75) Inventors: Raoul Florent, Ville D'Avray (FR); Sherif Makram-Ebeid, Dampierre (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/542,897

(22) PCT Filed: Jan. 16, 2004
(86) PCT No.: PCT/IB04/00138

§ 371 Date: Jul. 20, 2005

(30) Foreign Application Priority Data
Jan. 22, 2003 (EP) 03290162.1

(51) Int. Cl. G06K 9/40

(52) U.S. Cl. 382/261

(57) ABSTRACT

Image processing system for generating a multidimensional adaptive oriented filter to process image data in a number d of dimensions, comprising product means for producing weighted scalar coefficients [W₁(r), . . . Wᵢ(r), . . . W_{d}(r)] of a number d of vectors of an oriented basis of vectors by a number n of local vectors related to each point; combining means (Π) for producing a set of one-scalar weight coefficients [W(r)] from the combination of the weighted scalar products; and filtering means (g) for producing filtered image data [g(x)] from the combination of the image data [I(x)] with the one-scalar weight coefficients [W(r)]. The system further comprises a direction estimator (10) for providing, at each image point, an oriented orthogonal basis of a number d of vectors (e₁, . . . eᵢ, . . . e_{d}); a site generator (20) for providing n site vectors of a local vector support; and product means for computing d scalar products of vectors of the orthogonal basis by each of the n site vectors. This system may also comprise means for providing weighting means for the scalar products through scalar functions. The filtering means may comprise a weighted normalized sum of the image data by the one-scalar weight coefficients [W(r)].

### FIELD OF THE INVENTION

The invention relates to an image processing system and an image processing method to generate adaptive filters, whose supports are oriented according to local orientations of features of interest in an image to be processed. The invention more particularly relates to such processing system and method that are applied to medical images. The invention also relates to a medical examination apparatus having such an image processing system and means for display. The invention finds an application in the industry of image processing systems and medical examination apparatuses.

### BACKGROUND OF THE INVENTION

A method to smooth and filter images is disclosed in the publication “A Framework for Anisotropic Adaptive Filtering and Analysis of Sequences and volume” in IEEE International Conference on Acoustics, Speech and Signal Processing (ICASP); San Francisco, Mar. 23-26, 1992 ; p. 469-472, vol. 3, by H. Knutsson, L. Haglund and G. H. Granlund. The approach described in the cited publication makes use of quadrature and steerable filters having a set of different orientations including at least three different orientations in the case of 2-D image processing, and at least six different orientations in the case of 3-D image processing. The algorithm written from this approach requires the application of all the filters involved in the filtering of one image. The resulting algorithm complexity has been found to be high. So, the calculation time is particularly long.

### SUMMARY OF THE INVENTION

The present invention has for an object to provide an image viewing system having processing means to generate filters whose supports are oriented according to local orientations of features of interest in an image to be processed. In particular, it is an object of the invention to provide an image viewing system having analysis means for analyzing the content of a noisy image representing various objects in order to determine the direction of features of interest in an image; and having synthesis means for synthesizing filters whose supports are oriented for filtering noise or enhancing features in the image.

It is specifically an object of the invention to provide a system for generating such oriented filters whose supports do not present approximated shapes but instead present exact shapes that do not vary according to their angle of orientation. It is also an object of the invention to provide a system using very low complexity image processing techniques for generating such oriented filters.

Such an image viewing system is claimed in claim 1.

The system of the invention has very powerful means to constitute oriented filters. An advantage of the system of the invention is that the analysis means shows very low complexity of calculation, resulting in substantial computation saving. In addition, the synthesis means of the system of the invention can reproduce the exact shapes of some typically targeted enhancement filters, such as for example oriented Gaussian kernels. Besides, the computations means according to the invention can be efficiently implemented using very simple techniques. An other advantage of the system of the invention is that the required computation time is especially short. The system of the invention has means to constitute a very fast and general D-dimensional adaptive filter.

The system of the invention can be implemented so that it is minimally demanding in terms of input/output, thus making a very good filter candidate for general purpose processor implementation. In fact, the system of the invention presents the advantage that it does not require any memory means. Since at the present time, processing means are very efficient for producing results of calculations, but are not very efficient for extracting data from memories, hence, the system of the invention, which only comprises calculation means, is very efficient.

In advantageous embodiments of the invention, the user may dispose of control means for interacting with the analysis means to select features of interest in the image and/or with the synthesis means to select shapes of the filter supports.

The invention may refer to image data in which each data point (pixel or voxel) is attributed a single scalar intensity value. This can be extended to multi-spectral data in which several values are attributed to each data point. For example, in colored images, one may refer to Red, Green and Blue components. Multidimensional data can be dealt with, such as one dimension, spatial 2D, spatial 3D, spatial multidimensional data plus time data. When one of the dimension is time and when one aims at real-time results, the method of the invention may have recursive steps for using data recorded at previous instants.

### BRIEF DESCRIPTION OF THE FIGURES

The invention is described hereafter in detail in reference to diagrammatic figures, wherein:

FIG. 1 is a functional block diagram illustrating the means of the image viewing system;

FIG. 2A, FIG. 2B and FIG. 2C illustrate the generation of site vectors;

FIG. 3A represents a Gaussian weighting function f₁; FIG. 3B represents a Laplacian weighting function f₂; FIG. 3C represents a set of 2-D oriented kernels based on Gaussian and Laplacian weighting functions;

FIG. 4 illustrates the steps carried out by the viewing system of the invention;

FIG. 5 is a functional block diagram of a viewing system and a medical apparatus according to the invention.

### DESCRIPTION OF EMBODIMENTS

The invention relates to an image viewing system having processing means to generate filters whose supports are oriented according to local orientations of features of interest in an image to be processed. The invention relates to such a system for adaptive filtering of multidimensional signals for quality improvement application including noise reduction and the enhancement of valuable details. This system has processing means for achieving this goal in two steps: first means for signal analysis and, using the results of this analysis, second means for filter synthesis. In particular, the invention relates to an image viewing system having analysis means for analyzing the content of a noisy image representing various objects, in order to determine the direction of features of interest in an image; and having synthesis means for synthesizing filters with oriented supports apt to filter noise or enhance features in the image.

Specifically, the invention relates to an image processing system using analysis means that provides orientation of features of interest directly; and synthesis means for generating oriented filters having supports that do not present approximated shapes but instead exact shapes, which remain unchanged when their angles of orientation vary.

Besides, the invention has for an object to provide such a system that produce the results within short computation time using processing means that are simple to implement.

The system comprises means of acquisition of image data including point coordinates, denoted by x, and an intensity value, denoted by I(x), for each image point x. The proposed system deals with a multi-dimensional image, whose dimension is denoted by D. It is not excluded that D=2. For a D-dimensional image, each data point is defined by a D-tuple point x associated to coordinates of the form (x₁, x₂, . . . x_{D}) where each of the components x₁, x₂, . . . x_{D} varies in a predefined range, for instance 0<x₁<I₁; 0<x₂<I₂; 0<x_{D}<I_{D}. To each such D-tuple, corresponds an image value, which may be a single scalar value. In the case of a monochromatic image, the scalar value is the luminance intensity. For a color image, the image value may be represented by a set of three intensities representing the Red, Green and Blue components.

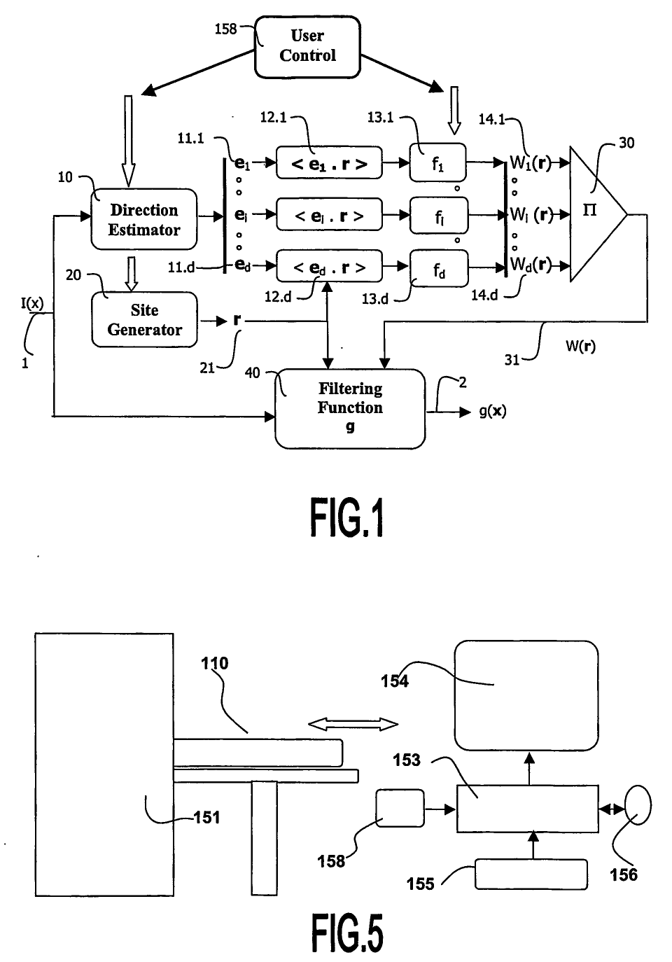

FIG. 1 is a block diagram of the image processing system of the invention. Referring to FIG. 1, the input image data I(x) are processed using the following processing means:

1) Analysis Means for Analyzing the Content of the Original Image.

The analysis means comprises a Direction Estimator 10 that receives the input image data I(x) referred to by 1 and that outputs, on a pixel basis, a set of multidimensional orthogonal unit vectors denoted by (e₁, . . . ,e_{d})^{T} where d is the input signal dimension. These vectors are aligned with a locally most prominent feature.

The nature of the feature on which direction should be estimated is user selectable. The user may interact for feature selection using the user control interface 158. For instance, the user visualizes the input image and selects in the image a feature of interest that may be an edge or a border of an object. Once the user has chosen a feature of interest, the system of the invention has means to determine the orientation angle of the feature of interest. Hence at each point of the image, the analysis means provides a corresponding set of d-dimensional orthogonal unit vectors. The Direction Estimator may use any technique known to those skilled in the art to determine the direction of the feature of interest. This technique may comprise gradient estimation (first order derivatives) or local curvature estimation (second order derivatives) or eigen values of the tensor of structure. There are numerous possible techniques of direction estimation.

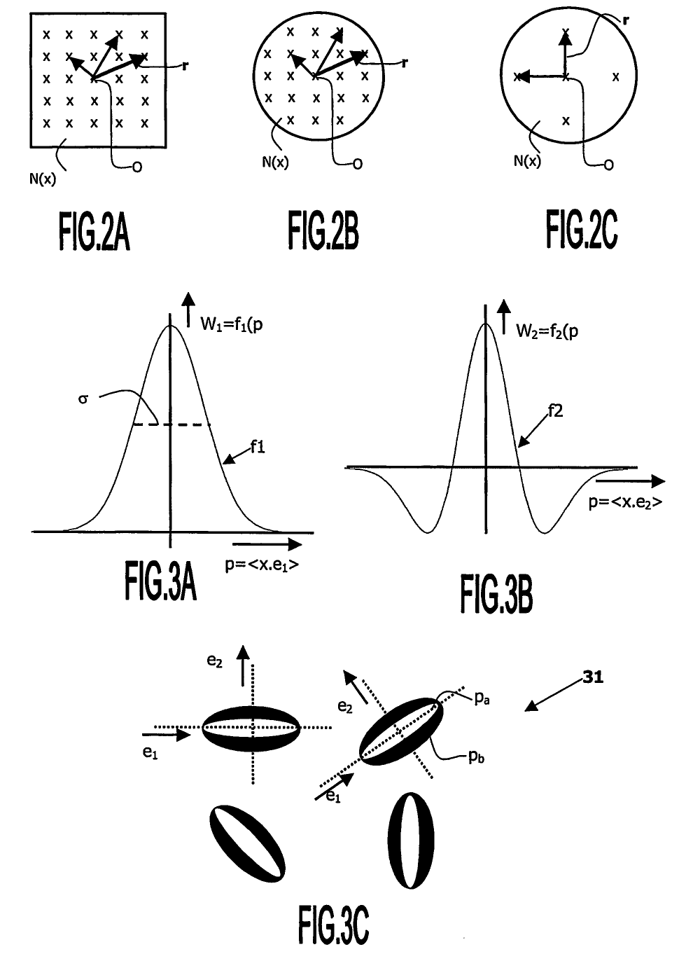

The analysis means further comprises a Site Generator 20, which produces a set of local vectors r spanning a filter window around a reference point. Referring to FIG. 2A, FIG. 2B and FIG. 2C, a small window, which comprises a few number n of points, is generated around a reference point, denoted by O, such as the center of the window. The window is a filter support that comprises the ensemble of points, which are used to calculate the output of the filter at the current point (x) of the image. For example in 2-D, the shape of the support may be a square, as shown in FIG. 2A, or a circle, as shown in FIG. 2B and FIG. 2C, and the reference point O may be the center of the square or the circle. The Site Generator 20 generates, for each current point (x) a set of n site vectors r, which is used to form a neighborhood N(x) around the current point (x). In FIG. 2A to 2C, only few vectors r are represented for simplicity. The user may interact, through the user control interface 158, in order to chose the shape and area of the filter support for the Site Generator 20. The set of n site vectors r of the neighborhood N(x) produced by the Site Generator 20 is passed on each point x of the image I(x) to be filtered.

Now, to a given current point x of the d-dimensional image, correspond a set of d orthogonal unit vectors denoted by (e₁, eᵢ, . . . ,e_{d})^{T} forming a d-dimensional orthogonal vector basis and a set of n site vectors denoted by r in the neighborhood N(x).

2) Synthesis Means for Synthesizing Oriented Filters.

The synthesis means comprises a scalar product unit outputting scalar products <e₁, r> referred to by 12.1 to 12.d. for each image point, the scalar product unit performs the product between each site vector r with all the vectors e₁ to e_{d} of the d-dimensional orthogonal basis.

The synthesis means further comprises a set of number d of elementary weight scalar functions f₁ to f_{d}, which transforms the scalar products into elementary weight coefficients. So, there is one function fᵢ( ) per vector eᵢ. Each scalar product <eᵢ, r> is regarded as the input of a scalar function fᵢ with (1≦i≦d). The elementary weight scalar functions f₁ to f_{d}, which receive the scalar values <e₁, r>, produce a number d of scalar weighting coefficients W₁ to W_{d} at their output.

The content of those scalar functions directly depends on the nature and amount of enhancement the user wants to apply on the selected feature. The nature of features and the amount of enhancement, which the user may want to apply on a given set of selected features, are user selectable. The nature of features and the amount of enhancement can be associated to predefined functions fᵢ. The functions fᵢ can be pre-loaded in selectable “Tables”. The user does not have to himself provide the functions fᵢ. Instead, the scalar functions can be selected from a predefined library. The user can pinpoint one “Table” of the library, each “Table” corresponding to a predefined “Taste” of the user. The user may select or modify the nature of the elementary weight scalar functions f₁ to f_{d}. To this end the user acts on the control means 158. The nature of the elementary weight scalar functions determines the nature of image processing that will be applied according to local directions determined by the orthogonal d-dimensional basis. If the user selects scalar function that always gives positive results, then smoothing filters will be generated. Instead, if the user selects scalar function that sometimes gives negative results, then enhancing filters can be generated.

For example, referring to FIG. 3A, where d=2 in a 2-D image, a Gaussian scalar weighting coefficient W₁(r)=f₁(p) with p=<e₁, r>, may be chosen on the vector of direction e₁. And then, referring to FIG. 3B, in said 2-D image, a Laplacian scalar weighting coefficient W₂(r)=f₂(p) with p=<e₂, r>, may be chosen on the vector of direction e₂, this Laplacian weighting coefficient W₂ being a symmetrical function outputting positive values inside a canal of abscissae near zero and producing negative values for the abscissae each side of the canal.

The synthesis means further comprises a combination unit 15 denoted by Π, which combines the number d of scalar weighting parameters W₁ to W_{d}. The combination unit gathers the elementary weights fᵢ(<eᵢ, r>) into a single scalar value W(r). In a preferred embodiment, the combination unit Π may be a product unit, which performs a simple d-term product between the scalar weighting parameters W₁ to W_{d} and which issues the weight coefficients W(r) of the site r that will be used to form adaptive oriented filter kernels in the filter to be generated.

Now, to each point of the image correspond a number n of sites and a number n of weight coefficients W(r), referred to by 31, each weight corresponding to a given site vector r. The filter coefficients W(r) are generated on the fly, which allows to filtering features in all kinds of directions.

3) Filter Generating Means.

The filter generation means are formed by a filtering function g, which may of the form given by the following formula:

$$g = \frac{{\sum }_{r} W ( r ) I ( x + r )}{{\sum }_{r} W ( r )} \qquad ( 1 )$$

According to this example, the filtering generation means are apt to generate a filter producing a normalized local weighted sum, which is performed at all the input pixels (x+r) of intensity I(x+r), within the neighborhood N(x), by the W(r) weights. Normalization is used to preserve the average of the signals. The normalization corresponds to divide the above weighted sum by the sum of the W(r) weights over the support S of the site neighborhood N(x).

For example, referring to FIG. 3C, using the scalar weighting coefficients W₁ and W₂, as illustrated by FIG. 3A and FIG. 3B, oriented filter kernels 31 are generated. A smoothing filter has a support length along e₁ that depends on the standard deviation value c of the Gaussian scalar f₁, from which the scalar weighting coefficient W₁ is calculated, and a support width along e₂ that depends on the width of the canal of the function f₂, from which the scalar weighting coefficient W₂ is calculated. The negative coefficients of W₂ in the portions disposed each side of the canal determine the strength of the enhancement provided by the filter generated according to the invention.

As illustrated by FIG. 3C, this operation of summing 15 is apt to produce an exact shape for the filter kernels 31, which are used to filter oriented features in the image. According to the invention, the filter kernels 31 are oriented along the current estimated directions e₁ to e_{d}. Besides, the filter kernels show the exact shapes produced by the use of the computed scalar weighting coefficients W₁ and W₂, which shapes are invariant whatever the filtering orientation angle.

Since the filter coefficients W(r) are generated on the fly, the synthesizing means does not generate specific filter banks of kernels with predefine sets of directions. Instead, the filtering means of the invention allows to filtering features in all kinds of directions.

The invariance of the filter support shapes in function of the filtering orientation angles is a unique, very important and very advantageous result of the invention.

In the case when the image intensities are multicomponent signals or vectorial, the combination formula (1) is still valid. This formula yields a weighted sum of vectors, in the case when all the signal components have the same directions. For instance, in the case of a signal comprising red, blue, green components, said signal components must have the same direction. When said signal components do not show the same directions, in that case, the filter of the invention may be used independently on each of the components of the signal. One direction is estimated for each signal component and one set of weighting coefficients W(r) is further estimated for each component and each image point. Then, formula (1) is applied for each signal component independently.

4) Advantages.

This image processing system is able to produce the exact form of some typically targeted enhancement filters including oriented Gaussian kernels, as illustrated by FIG. 3A to 3C. In addition, it constitutes a very fast and general d-dimensional adaptive filtering system. Furthermore, the system can be implemented so that it becomes minimally demanding in terms of input/output, thus making a very good filter candidate for general purpose processor implementation.

This system is not demanding any complexity regarding the choice of the direction estimation means. The choice is up to the user. The direction estimation means may be based on simple gradient calculation or on more elaborate calculation of eigen vectors of tensors of structure or on Heissen functions giving the orientation of principal curvatures.

The filter kernels W(r) are generated on the fly, which allows to filtering features in all kinds of directions. There is no filter bank with predefine sets of directions.

The system uses principally scalar functions and scalar products, which are particularly simple to implement. The use of scalar products produces particularly rapid results, since they may be estimated in an incremental manner with a simple supplementary addition for each further product.

The weighting scalar functions may be simply tabulated, using very small tables since they are only applied to the dimensions related to the dimensions of the filter used in the site generation. In fact, the scalar products fᵢ(<eᵢ . r>) are inferior to the radius of said filter support. Hence, the tabulated functions are applied to the few points corresponding to the very small support.

The function of combination Π may be very simple, especially in the case when d=2 and Π is a product, thus being a product of two terms. After having applied this simple function of combination Π, the next operation is a simple normalized weighted sum.

Hence, the total cost of filter generation and filtering operation according to the invention is extremely low. This low cost does not prevent the system of the invention to produce very interesting shapes of filter kernels, provided that appropriate weighting function fᵢ are chosen, such as illustrated by FIG. 3A to 3C.

The filter generation means according to the invention does not require any intermediary memory means. All the computations are performed in a continuous way. Since processors are very efficient in the computing steps and show low efficiency in extracting data from memory, the system of the invention is very appropriate to be associated to computers.

The filter of the invention may be applied in the spatial domain. However, since it may be applied to any number d of dimensions and since no specific technique for determining direction is imposed, then it may be applied in spectral domain to transformation coefficients such as FET, DCT Hermite transforms, Hermite wavelets etc. or on sub-bands of Gaussian or Laplacian pyramid.

5) Image Processing Method.

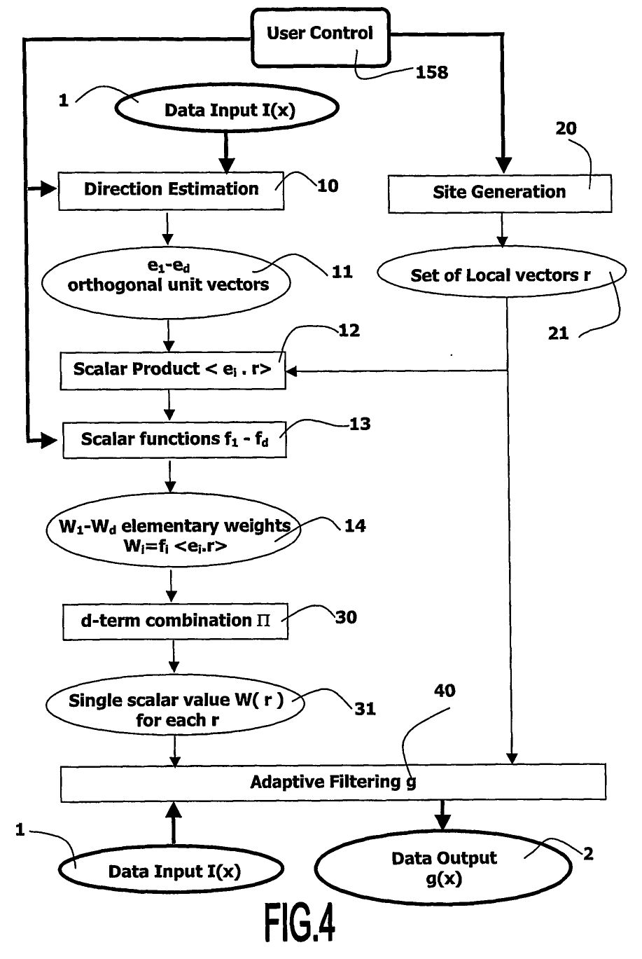

Referring to FIG. 4, the image processing method, for generating a multidimensional adaptive oriented filter to process image data in a number d of dimensions, operated by the above-described system comprises steps of:
computing, for each point of the image, a number d of scalar products, <e₁.r> to <e_{d}.r>, of a number d of vectors, e₁ to e_{d}, of an oriented vectors basis by a number n of site vectors r defined on a neighborhood N(x) of the point, said neighborhood including n points. The scalar products are respectively weighted by a number d of weighting functions, f₁ to f_{d}, to produce a number d of weighted scalar coefficients W₁(r) to W_{d}(r);
combining in step Π the weighted scalar coefficients W₁(r) to W_{d}(r) for producing a set of one-scalar weight coefficients W(r) over said neighborhood N(x) that define adaptive oriented filter kernels [w(r)]; and
filtering the image data by a function g for producing filtered image data g(x) from the combination of the image data I(x+r), defined over the neighborhood N(x), with the set of one-scalar weight coefficients W(r) forming the adaptive oriented filter kernels [w(r)].

This method particularly comprises steps of:
direction estimation 10 for providing, at each image point, an oriented orthogonal vector basis of a number d of vectors e₁ to e_{d};
a site vector generation 20 for providing n site vectors over a local vector support, which is formed by a neighborhood N(x) of n points around each image point; and
computation of d scalar products <eᵢ . r> of the vectors e₁ to e_{d} of the orthogonal vector basis by the n site vectors r; and weighting the scalar products <eᵢ . r> through a number d of scalar weighting functions f₁ to f_{d}.

According to this method, the combination means Π for producing a one-scalar weight coefficients W(r) is a d-terms product; the vectors of the oriented basis of vectors are produced by a direction estimation step 10 that includes estimation of directions based on gradient estimation or eigen vectors of Hessien or of tensors of structure; the weighting functions comprise Gaussian functions and/or symmetrical functions whose output is positive for values near zero inside a canal and is negative each side of the canal beyond the canal.

6) Medical Viewing System and Apparatus

The above-described means and steps can be implemented in the viewing system of the invention. FIG. 5 shows the basic components of an embodiment of an image viewing system in accordance to the present invention, incorporated in a medical examination apparatus. The medical examination apparatus 151 may include a bed 110 on which the patient lies or another element for localizing the patient relative to the imaging apparatus. The medical imaging apparatus 151 may be a CT scanner or other medical imaging apparatus such as x-rays or ultrasound apparatus. The image data produced by the apparatus 151 is fed to data processing means 153, such as a general-purpose computer, that carries out the steps of the method. The data processing means 153 is typically associated with a visualization device, such as a monitor 154, and an input device 155, such as a keyboard, or a mouse 156, pointing device, etc. operative by the user so that he can interact with the system. The data processing device 153 is programmed to implement a method of processing medical image data according to invention. In particular, the data processing device 153 has computing means and memory means to perform the steps of the method. A computer program product having pre-programmed instructions to carry out the method may also be implemented.

The drawings and their description herein before illustrate rather than limit the invention. It will be evident that there are numerous alternatives that fall within the scope of the appended claims. Moreover, although the present invention has been described in terms of generating image data for display, the present invention is intended to cover substantially any form of visualization of the image data including, but not limited to, display on a display device, and printing. Any reference sign in a claim should not be construed as limiting the claim.

1. Image processing system for generating a multidimensional adaptive oriented filter to be applied to the point intensities of an image formed in a number d of dimensions, comprising:
processing means for producing, from the image point intensities [I(x)], adaptive oriented filter coefficients [w(r)] formed through combination (Π) of weighted scalar coefficients [w₁(r) . . . wᵢ(r) . . . w_{d}(r)], which coefficients are weighted scalar products [wᵢ=fᵢ(<eᵢ . r>)] of a number d of vectors (e₁ . . . eᵢ . . . e_{d}) of an oriented vectors basis, by a number n of local vectors (r) estimated over a neighborhood [N(x)) around the current image point.

2. Image processing system of claim 1, comprising:
product means for producing the weighted scalar coefficients [W₁(r), . . . ,Wᵢ(r), . . . W_{d}(r)];
combination means (Π) for combining the weighted scalar coefficients to produce a set of one-scalar weight coefficients [W(r)] forming the adaptive oriented filter kernels; and
filtering means (g) for producing filtered image data [g(x)] from the combination of the image data [I(x+r)] over the neighborhood [N(x)] with the one-scalar weight coefficients [W(r)].

3. The system of one of claim 1, comprising:
a direction estimator (10) for providing, at each image point, an oriented orthogonal basis of a number d of vectors (e₁-e_{d});
a site generator (20) for providing n site vectors forming a neighborhood [N(x)] of the image points; and
product means for computing a number d of scalar products [<eᵢ r>] of the vectors of the orthogonal vector basis for each of the n site vectors (r), for each image point.

4. The system of one of claim 1, comprising:
weighting means for weighting the scalar products [<eᵢ . r>] through scalar functions (fᵢ).

5. The system of claim 1, comprising:
filtering means including a weighted normalized sum of the products of image data [I(x+r)] over the neighborhood [N(x)] of the image points by the one-scalar weight coefficients [W(r)] forming the adaptive oriented filter kernels.

6. The system of claim 1, wherein:
the combination means (Π), for producing the set of one-scalar weight coefficients [W(r)] forming the adaptive oriented filter kernels, is a d-terms product.

7. The system of claim 1, wherein:
the direction estimator (10) for producing the vectors of the oriented vector basis includes direction estimation means for estimating direction of image features based on gradient estimation or eigen vectors of Hessien or of tensors of structure.

8. The system of claim 1, comprising:
weighting means for producing the weighting functions chosen among Gaussian functions and/or symmetrical functions whose output is positive for values near zero inside a canal and is negative each side of the canal beyond the canal.

9. The system of claim 1, comprising control means for the user to select image oriented features to be processed through the direction estimator (10) and/or the type of neighborhood [N(x)] for the Site Generator (20).

10. The system of claim 1, comprising control means for the user to choose the shape of the weighting functions (fᵢ), for selecting the amount of filtering, which corresponds to positive coefficients, and for selecting the amount of enhancement, which corresponds to negative coefficients.

11. Image processing method for generating a multidimensional adaptive oriented filter to process image data in a number d of dimensions, using a system as Claimed in claim 1, comprising steps of:
computing, from the image point intensities [I(x)], adaptive oriented filter kernels [w(r)] formed through the combination (Π) of weighted scalar coefficients [W₁(r) . . . Wᵢ(r) . . . W_{d}(r)], which coefficients are weighted scalar products [Wᵢ=fᵢ(<eᵢ . r>)] of a number d of vectors of an oriented vectors basis (e₁ . . . eᵢ . . . e_{d}), by a number n of local vectors (r) estimated over a neighborhood [N(x)] around the current image point;
filtering (g) the image data [I(x+r)] by the adaptive oriented filter kernels [w(r)] for producing filtered image data [g(x)] over the neighborhood [N(x)].

12. Medical examination apparatus comprising means to acquire d-dimensional image data [I(x)], a system as Claimed in claim 1 and further comprising a display system (154) for visualizing processed images and user control means (158) for selecting weighting functions and/or acting on the direction estimator and/or the site generator.

13. A computer program product comprising a set of instructions for carrying out the method as claimed in claim 11.
